(19) United States
(12) Patent Application Publication
(10) Pub. No.: US 2005/0231446 A1
(43) Pub. Date: Oct. 20, 2005

(54) Plasma display apparatus and image processing method thereof

(75) Inventors: Joo Young Lee, Suwon-si (KR); Seung Chan Baek, Seoul (KR); Name Jin Kim, Seoul (KR); Geun Soo Lim, Seongnam-si (KR); Chang Ho Hyeon, Yongin-si (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/104,587

(22) Filed: Apr. 13, 2005

(30) Foreign Application Priority Data
Apr. 14, 2004 (KR) 10-2004-0025923

(51) Int. Cl. G09G 3/28

(52) U.S. Cl. 345/63

(57) ABSTRACT

The present invention relates to a plasma display apparatus and image processing method thereof, by which low-gray-scale expression power can be enhanced and by which halftone noise occurring in video signal implementation can be reduced. According to an embodiment of the present invention, a plasma display apparatus includes an inverse gamma correction unit performing inverse gamma correction on data of a video signal inputted from outside and a halftone unit diffusing an error component resulting from multiplying a decimal value of a gray scale value of the inverse-gamma-corrected data by each error diffusion coefficient allocated according to the gray scale value into a neighbor cell.

This Nonprovisional application claims priority under 35 U.S.C. § 119(a) on Patent Application No. 10-2004-0025923 filed in Korea on Apr. 14, 2004, the entire contents of which are hereby incorporated by reference.

### BACKGROUND OF THE INVENTION

1. Field of the Invention

The present invention relates to a plasma display apparatus, and more particularly, to a plasma display apparatus and image processing method thereof, by which gray scale display capability is enhanced and by which halftone noise can reduced.

2. Description of the Background Art

Generally, in a plasma display apparatus, a barrier rib provided between a front substrate and a rear substrate configures one unit cell. And, each cell is filled up with a main discharge gas such as Ne, He and (Ne+He) and an inert gas including a small quantity of Xe. When electric discharge occurs by radio frequency voltage, the inert gas generates vacuum UV (ultraviolet) rays that excite a fluorescent substance between the barrier ribs to implement an image. Such a plasma display apparatus, which enables its thin and light configuration, is spotlighted as a next generation display apparatus.

FIG. 1 is a perspective diagram of a general plasma display panel.

Referring to FIG. 1, in a plasma display panel, a front substrate 100 as a display face to display an image thereon and a rear substrate 110 as a backside of the plasma display panel are assembled to each other to leave a predetermined distance from each other. The front substrate 100 consists of a front glass 101 on which a plurality of sustain electrode pairs are formed. In this case, a scan electrode 102 and a sustain electrode 103 forms each of a plurality of the sustain electrode pairs. The rear substrate 110 consists of a rear glass 111 on which a plurality of address electrodes 113 are arranged to cross with a plurality of the sustain electrode pairs.

The front substrate 100 includes the scan electrode 102 and the sustain electrode 102 for mutual discharge in one discharge cell and for sustaining light emission of the cell. Namely, the scan electrode 102 consisting of a transparent electrode a formed of a transparent ITO substance and a bus electrode b formed of a metal based material and the sustain electrode 103 consisting of another transparent electrode a formed of a transparent ITO substance and another bus electrode b formed of a metal based material configure the sustain electrode pair. The scan and sustain electrodes 102 and 103 are covered with at least one dielectric layer 104 restricting a discharge current and insulating the electrode pairs from each other. And, a protecting layer 105 is formed on the upper dielectric layer 104 by depositing MgO thereon to facilitate discharge conditions.

On the rear substrate 110, a plurality of stripe or well type barrier ribs 112 are arranged parallel to each other to form a plurality of discharge spaces, i.e., discharge cells. And, a plurality of the address electrodes 113 are arranged parallel to a plurality of the barrier ribs 112 in-between to generate vacuum ultraviolet rays by address discharge. An R/G/B fluorescent material 114 is coated on an upper surface of the rear substrate 110 to emit visible rays for image display on the address discharge. And, another dielectric layer 115 is provided between the address electrodes 113 and the florescent material 114 to protect the address electrodes 113.

FIG. 2 is a graphical diagram for explaining a method of implementing an image in a plasma display apparatus according to a related art.

Referring to FIG. 2, in a method of implementing an image in a plasma display apparatus according to a related art, one frame is divided into a plurality of subfields differing from each other in a discharge number. And, light is emitted from a plasma display panel for the subfield corresponding to a gray scale value of an inputted video signal.

Each of the subfields is divided again into a reset period for generating discharge uniformly, an address period for selecting discharge cells, and a sustain period for implementing a gray scale according to a discharge number. For instance, in case of attempting to display an image by 256 gray scales, a frame of 16.67 ms corresponding to 1/60 second is divided into eight subfields SF1 To SF8.

Each of the eight subfields SF1 To SF8 is subdivided into the reset period, the address period and the sustain period. In this case, the sustain period increases in each of the subfields by a ratio of 2ⁿ, where n=0, 1, 2, 3, 4, 5, 6 and 7. Since the subfields differ from each other in the sustain period, the gray scale of image can be implemented.

FIG. 3 is a comparison graph of luminance characteristics of a plasma display apparatus and a cathode ray tube.

Referring to FIG. 3, a cathode ray tube or a liquid crystal display represents a specific gray scale by controlling a displayed light for an inputted video signal according to an analog system, thereby having a non-linear luminance characteristic. Yet, a plasma display apparatus represents by modulating a number of light pulses using a matrix array of discharge cells that can be turned on/off, thereby having a linear luminance characteristic. And, such a gray scale representing method is called PWM (pulse width modulation).

In this case, since a brightness characteristic for display current is proportional to the 2.2 multiplier, the display apparatus such as a cathode ray tube transmits an inputted external video signal such as a broadcast signal corresponding to an inverse of the 2.2 multiplier. Hence, a plasma display apparatus having a linear brightness characteristic needs to perform inverse gamma correction on a video signal inputted from outside.

FIG. 4 is a graph of inverse gamma correction in a plasma display apparatus according to a related art.

In FIG. 4, target luminance indicates an ideal inverse gamma correction result to be corrected, real luminance indicates a measured luminance value appearing as a result after inverse gamma correction, and PbP luminance represents a luminance value, which is equal to or smaller than 3, measured without inverse gamma correction.

Referring to FIG. 4, in the target luminance, gray scale values of 61 steps between 0˜60 are represented by different luminance values, respectively. Yet, in the real luminance, gray scale values of 61 steps between 0˜60 are represented by eight kinds of luminance values only. So, it is unable to implement sufficient gray scale representation when inverse gamma correction is carried out in the plasma display apparatus. Hence, contour noise takes place so that massed image shows up.

To represent insufficient gray scales of a plasma display apparatus, a halftone method such as dithering and error diffusion has been used.

First of all, dithering is explained with reference to FIG. 5A and FIG. 5B as follows.

FIG. 5A and FIG. 5B are diagrams for explaining a dithering method in a plasma display apparatus according to a related art. FIG. 5A shows a 2×2 dither mask and FIG. 5B shows a dither mask pattern by a 4×4 dither mask. The dithering method, as shown in FIG. 5A, is a method of dithering a presence or non-presence of carry occurrence by comparing a gray scale value of each cell to a specific threshold. In this case, by turning on a cell where the carry takes place or by turning off a cell where the carry does not take place, the insufficient gray scale representing power is tried to be raised.

And, the dithering method is a method of allowing contour noise to avoid being caught sight of by adding suitable noise. In the related art, 3-dimensional dither mask patterns corresponding to a multitude of frames, lines and rows of the plasma display apparatus are repeatedly used.

Referring to FIG. 5B, dither mask patterns A, B, C and D are used alternately and periodically for each frame in inputting a vertical signal. Namely, the mask pattern A is used for a first frame and the mask pattern B is used for a second frame. If the first and second frames are accumulated by time, sixteen cells are evenly turned on overall.

Yet, in case that one cell, as shown in FIG. 5B, is moved in a frame of the mask pattern B, eight cells are turned off. In this case, flicker occurs due to overall luminance variation. In case each cell is moved in a diagonal direction, dither pattern noise takes place.

Thus, the related art dithering method generates the dither noise in a specific gray scale, thereby degrading quality of image. And, the related art dithering method uses the 3-dimensional dither mask patterns without identifying low and high gray scales, whereby flicker takes place in representing low gray scale.

Error diffusion is explained with reference to FIG. 6A and FIG. 6B as follows.

FIG. 6A and FIG. 6B are diagrams of an error diffusion method in a plasma display apparatus according to a related art. FIG. 6A is a diagram for explaining an error diffusion method according to a related art and FIG. 6B is a schematic diagram of error diffusion execution between cells according to a related art.

Referring to FIG. 6A, an error diffusion method is a method of solving correction of a decimal value, i.e., error discarded after inverse gamma correction by diffusing an error component of data corresponding to each cell into a neighbor cell.

In doing so, the error diffusion method is carried out in a manner of diffusing an error component resulting from multiplying a decimal value by an error diffusion coefficient according to neighbor cells. For instance, after an error component resulting from multiplying a decimal value of a cell-A by an error coefficient of 1/16, an error component resulting from multiplying a decimal value of a cell-B by an error coefficient of 5/16, an error component resulting from multiplying a decimal value of a cell-C by an error coefficient of 3/16 and an error component resulting from multiplying a decimal value of a cell-D by an error coefficient of 7/16 have been added together, the added value is diffused into a next cell-E.

Referring to FIG. 6B, error diffusion is carried out by cell and line unit. Error components transferred from the cells A, B C and D are added to the cell E. And, uni-directional diffusion, of which a diffusion direction is left to right on each line, is performed.

FIG. 7 is a diagram of a video displayed by an error diffusion method according to a related art.

Referring to FIG. 7, a video displayed by an error diffusion method according to a related art has an error diffusion pattern and directionality of diffusion in a low gray scale area. An arrow-A indicates directionality of error diffusion having an error diffusion direction of 45°. And, an area-B indicates an error diffusion pattern spearing at a specific gray scale.

However, in the related art error diffusion method, the diffusion direction of the error component is set to the unidirection and diffusion is performed by multiplication by a constant error diffusion coefficient. Hence, the related art method generates the diffusion pattern having directionality and the error diffusion pattern accumulated at a specific gray scale.

### SUMMARY OF THE INVENTION

Accordingly, an object of the present invention is to solve at least the problems and disadvantages of the background art.

An object of the present invention is to provide a plasma display apparatus and image processing method thereof, by which low-gray-scale expression power can be enhanced.

Another object of the present invention is to provide a plasma display apparatus and image processing method thereof, by which halftone noise occurring in video signal implementation can be reduced.

According to an embodiment of the present invention, a plasma display apparatus includes an inverse gamma correction unit performing inverse gamma correction on data of a video signal inputted from outside and a halftone unit diffusing an error component resulting from multiplying a decimal value of a gray scale value of the inverse-gamma-corrected data by each error diffusion coefficient allocated according to the gray scale value into a neighbor cell.

According to an embodiment of the present invention, an image processing method of a plasma display apparatus includes an inverse gamma correction step of performing inverse gamma correction on data of a video signal inputted from outside and a halftone step of diffusing an error component resulting from multiplying a decimal value of a gray scale value of the inverse-gamma-corrected data by each error diffusion coefficient allocated according to the gray scale value into a neighbor cell.

According to an embodiment of the present invention, an image processing method of a plasma display apparatus includes an inverse gamma correction step of performing inverse gamma correction on data of a video signal inputted from outside and a halftone step of diffusing an error component resulting from multiplying a decimal value of a gray scale value of the inverse-gamma-corrected data by an error diffusion coefficient into a neighbor cell in a random direction.

According to an embodiment of the present invention, an image processing method of a plasma display apparatus includes an inverse gamma correction step of performing inverse gamma correction on data of a video signal inputted from outside and a halftone step of diffusing an error component resulting from multiplying a decimal value of a gray scale value of the inverse-gamma-corrected data by each error diffusion coefficient allocated according to the gray scale value into a neighbor cell in a random direction.

Therefore, by the embodiments of the present invention, gray-scale expression power is raised in a manner of applying different error diffusion coefficients according to gray scale values, respectively. And, the error diffusion direction is randomly set to solve the problem attributed to the unidirection of the related art. Moreover, by using at least two lookup tables storing information or error coefficients according to gray scales therein, gray scale expression is densely performed and halftone noise occurring in a specific area can be reduced.

### BRIEF DESCRIPTION OF THE DRAWINGS

The invention will be described in detail with reference to the following drawings in which like numerals refer to like elements.

FIG. 1 is a perspective diagram of a general plasma display panel.

FIG. 2 is a graphical diagram for explaining a method of implementing an image in a plasma display apparatus according to a related art.

FIG. 3 is a comparison graph of luminance characteristics of a plasma display apparatus and a cathode ray tube.

FIG. 4 is a graph of inverse gamma correction in a plasma display apparatus according to a related art.

FIG. 5A and FIG. 5B are diagrams for explaining a dithering method in a plasma display apparatus according to a related art.

FIG. 6A and FIG. 6B are diagrams of a error diffusion method in a plasma display apparatus according to a related art.

FIG. 7 is a diagram of a video displayed by an error diffusion method according to a related art.

FIG. 8 is a schematic block diagram of a plasma display apparatus according to one embodiment of the present invention.

FIG. 9 and FIG. 10 are diagrams for explaining error diffusion coefficients according to one embodiment of the present invention.

FIG. 11 is a lookup table of error diffusion coefficients according to one embodiment of the present invention.

FIG. 12 is a diagram of an image represented according to significant figures of a coefficient of one embodiment of the present invention.

FIG. 13 is a diagram for explaining an error diffusion direction according to one embodiment of the present invention.

FIG. 14 is a diagram of a video displayed according to one embodiment of the present invention.

FIG. 15 is a block diagram for explaining a halftone method according to one embodiment of the present invention.

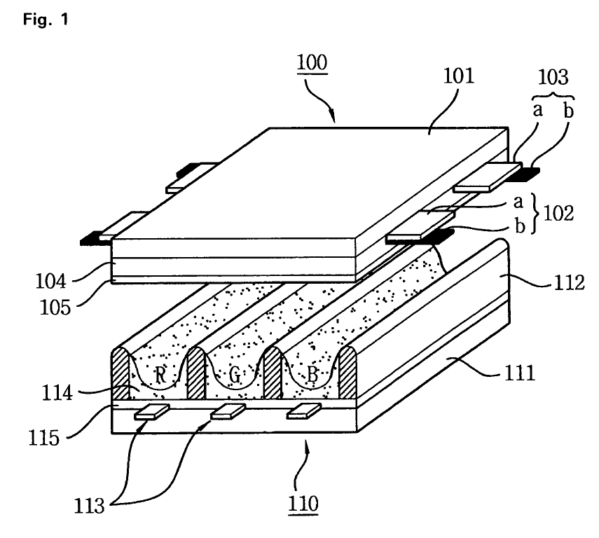

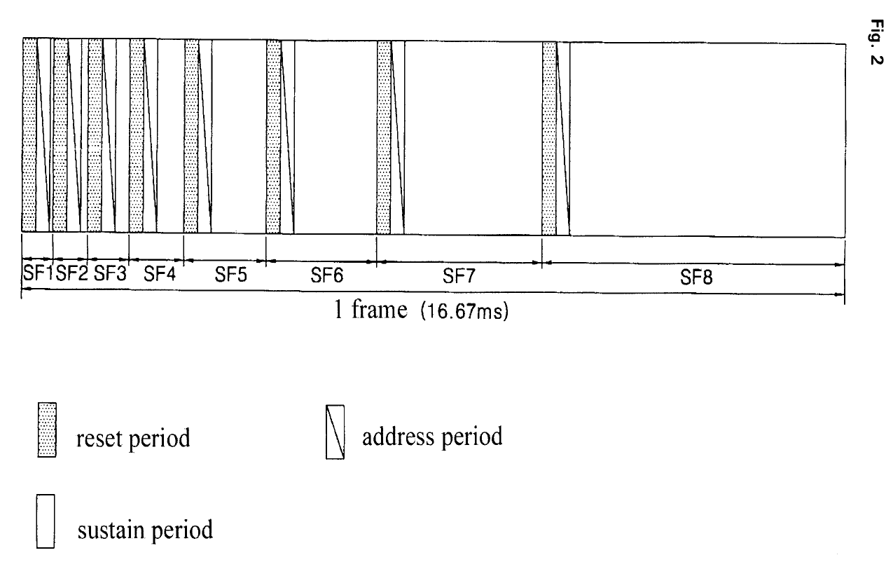

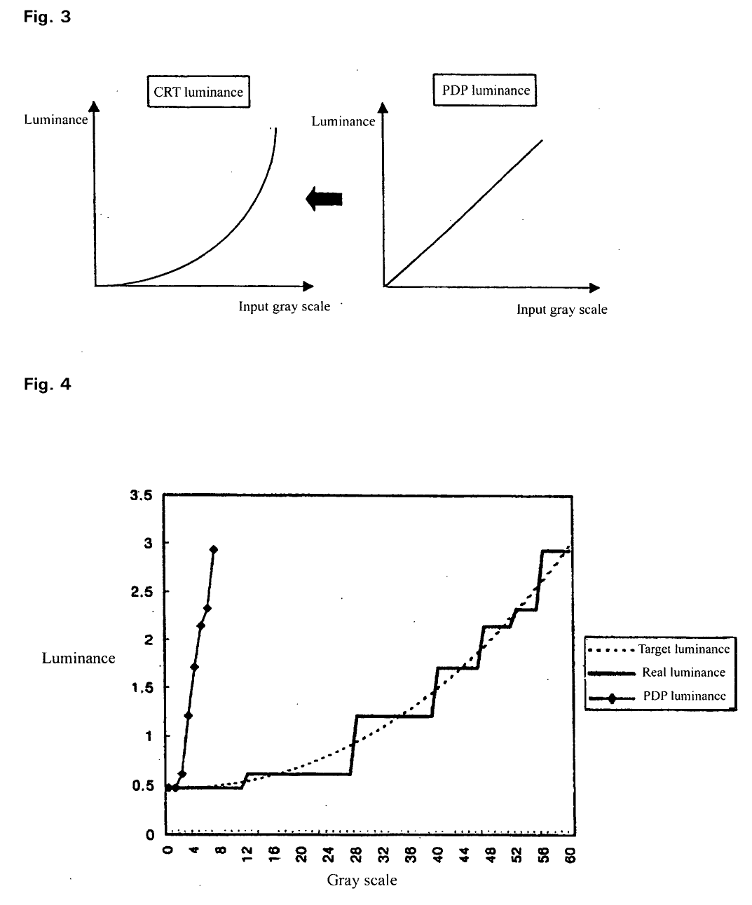

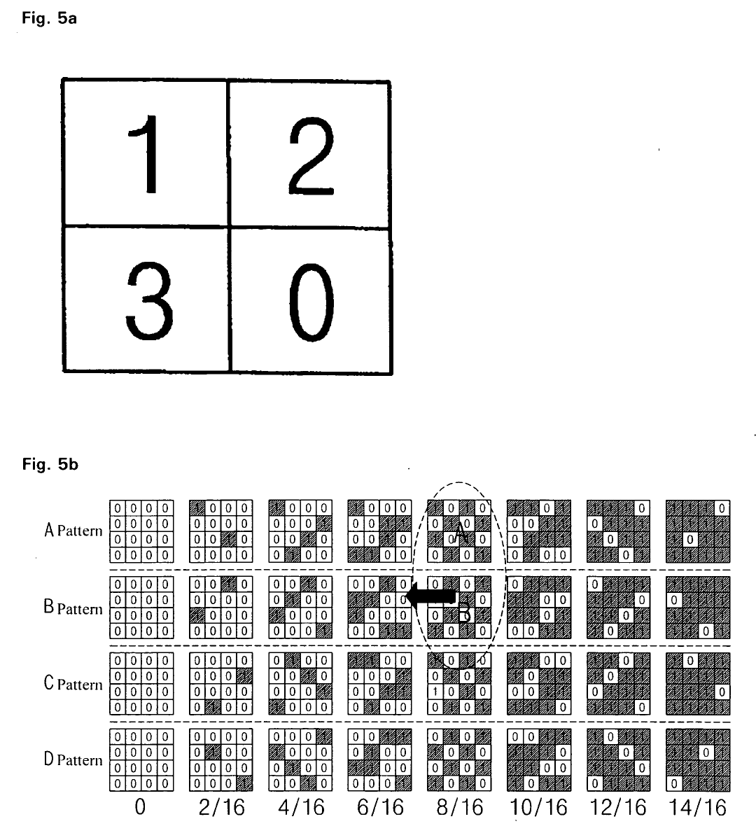

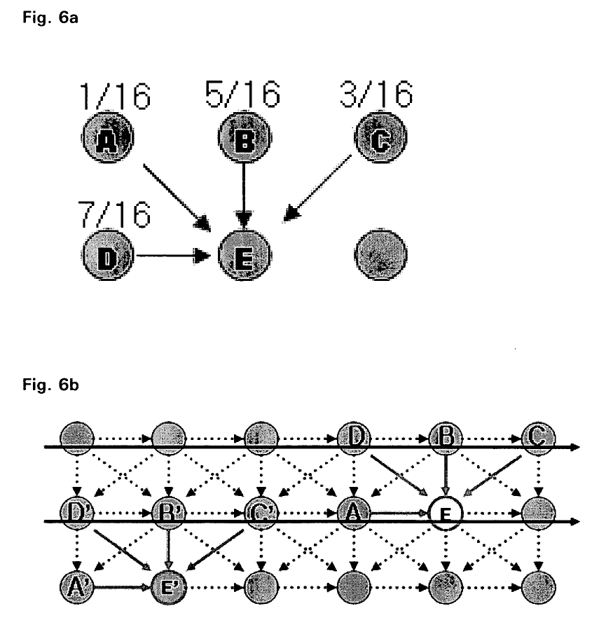

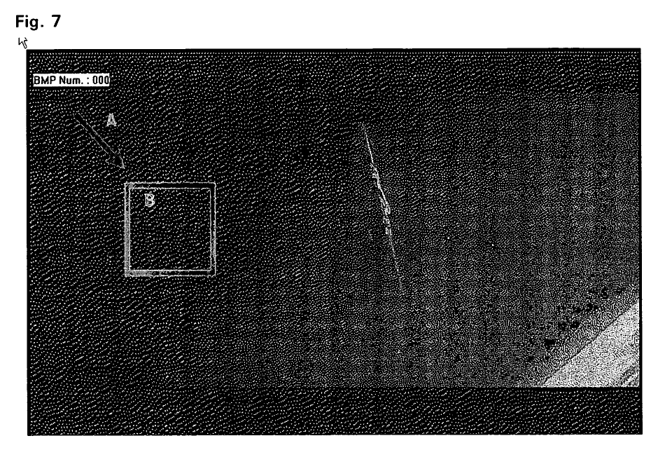

### DETAILED DESCRIPTION OF PREFERRED EMBODIMENTS

Preferred embodiments of the present invention will be described in a more detailed manner with reference to the drawings.

Hereinafter, the embodiments of the present invention will be described with reference to the drawings.

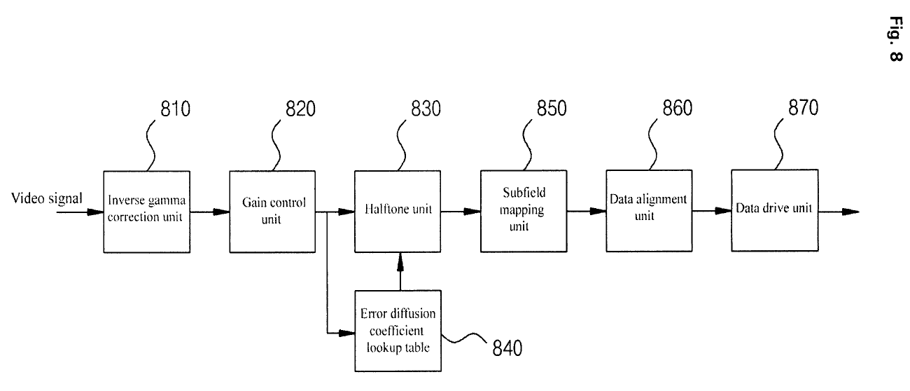

First of all, FIG. 8 is a schematic block diagram of a plasma display apparatus according to one embodiment of the present invention.

Referring to FIG. 8, a plasma display apparatus according to one embodiment of the present invention includes an inverse gamma correction unit 810, a gain control unit 820, a halftone unit 830, an error diffusion coefficient lookup table storing unit 840 and a subfield mapping unit 850.

The inverse gamma correction unit 810 performs inverse gamma correction on inputted video signal data to linearly convert a luminance value displayed according to a gray scale value of an inputted video signal.

The gain control unit 820 adjusts a gain per red, green or blue by multiplying an video signal of R (red), G (green) or B (blue), which is inverse-gamma-corrected by the inverse gamma correction unit 810, by a gain value adjustable by a user or set maker. In doing so, the user or set maker can set up a specific color temperature by the gain control unit 820.

The halftone unit 830 finely adjusts a luminance value represented according to a gray scale value by diffusing an error component into neighbor pixels for a video signal inputted from the gain control unit 820, thereby improving gray scale expression power.

The halftone unit 830 diffuses the error component, resulting from multiplying a decimal value of a gray scale value of inverse-gamma-corrected data by each error diffusion coefficient allocated according to the gray scale value, into a neighbor cell. In this case, owing to the error diffusion coefficient lookup table storing unit 840, information of the error diffusion coefficient allocated according to the gray scale value is previously stored. And, the halftone unit 830 receives the error diffusion coefficient information from the error diffusion coefficient lookup table storing unit 840 to execute the error diffusion. Moreover, the error diffusion coefficient lookup table storing unit 840 is provided within or outside the halftone unit 830.

In this case, the halftone unit 830 selectively uses a plurality of error diffusion coefficient lookup tables differing in the information of the error diffusion coefficient for each frame. Moreover, it is preferable that significant figures of the error diffusion coefficient is set to at least six bits.

And, the halftone unit 830 according to one embodiment of the present invention is characterized in diffusing the error diffusion component into neighbor cells in a random direction.

Moreover, the halftone unit 830 performs halftoning on upper bits of the decimal value of the gray scale value of the inverse-gamma-corrected data through dithering and lower bits of the decimal value through error diffusion, which will be explained in detail later.

The subfield mapping unit 850 maps the video signal inputted from the halftone unit 830 to a previously set subfield mapping table.

A data alignment unit 860 aligns spatially aligned subfield mapping data inputted from the subfield mapping unit 850 into time data.

And, a data driving unit 870 receives the data aligned according to time by the data alignment unit 860 to supply an address drive pulse to an address electrode (not shown in the drawing) of a plasma display panel, thereby implementing image on the plasma display panel.

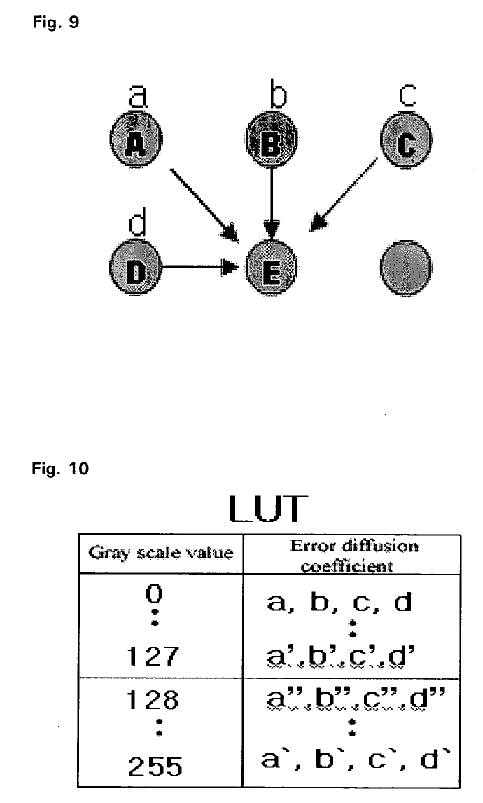

FIG. 9 and FIG. 10 are diagrams for explaining error diffusion coefficients according to one embodiment of the present invention.

Referring to FIG. 9, in error diffusion, each error diffusion coefficient of pixels A, B, C and D is differently applied according to a gray scale value of a center cell E. And, the error diffusion coefficients configure the lookup table in FIG. 10. Namely, the lookup table including information of each of the coefficients allocated according to the gray scale value is previously stored. If a total of error components resulting from multiplying the gray scale values of the neighbor pixels by the error diffusion coefficients, respectively is equal to or greater than 1, a carry occurs at the corresponding cell to be transferred to an upper digit.

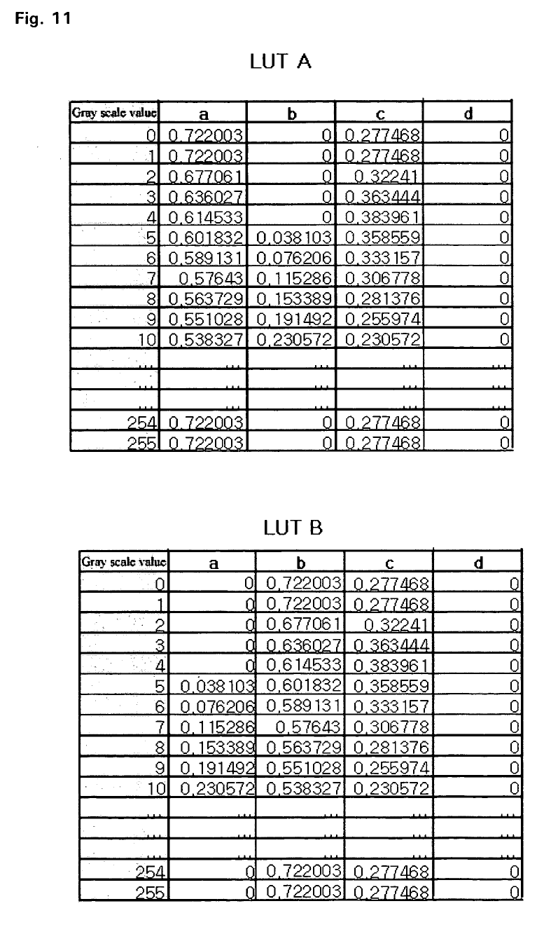

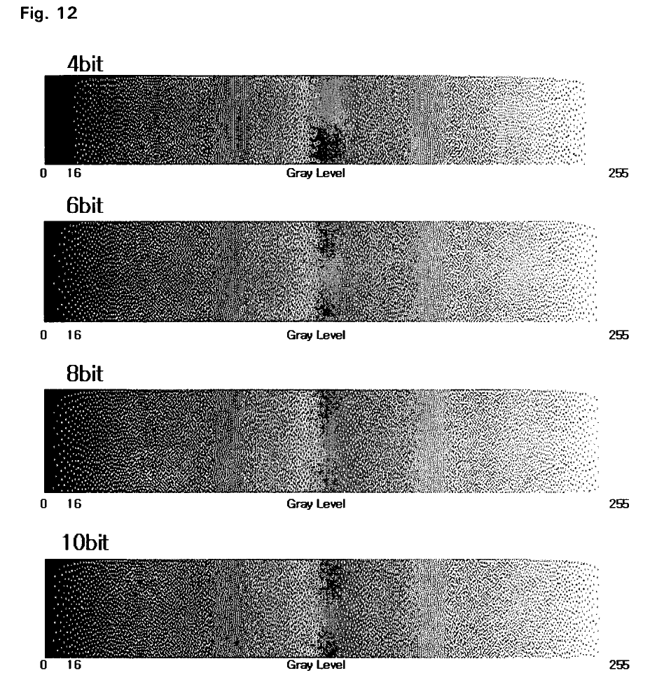

FIG. 11 is a lookup table of error diffusion coefficients according to one embodiment of the present invention. Referring to FIG. 11, coefficients a and b can be alternately used per frame using a lookup table including at least two error diffusion coefficients. The coefficients of the lookup table are experimentally decided by considering image quality influence according to the grays scales, respectively. In this case, a total of error diffusion coefficients a, b, c and d is 1.

Preferably, a plurality of lookup tables differing from each other in error diffusion coefficient information are sequentially used for each frame. By using the coefficients a, b, c and d alternately for each frame, gray scale expression power can be enhanced.

FIG. 12 is a diagram of an image represented according to significant figures of a coefficient of one embodiment of the present invention.

Referring to FIG. 12, images displayed according to gray scale values of 0˜255 are shown when significant figures of an error diffusion coefficient according to one embodiment of the present invention is varied to 10-bits from 4-bits. In an area 0˜16 (hereinafter called low-gray-scale area) of the image having 4-bit significant figures, the image is identically black. Namely, even if the gray scale value is varied between 0˜16, the identical black image is displayed to have poor gray scale expression power. And, it can be also seen that gray scale expression power is enhanced in the low-gray-scale area according to the incremented bit number of the significant figures. Hence, it is preferable in the present invention that the significant figures of the coefficient according to one embodiment of the present invention is set to at least 6-bits.

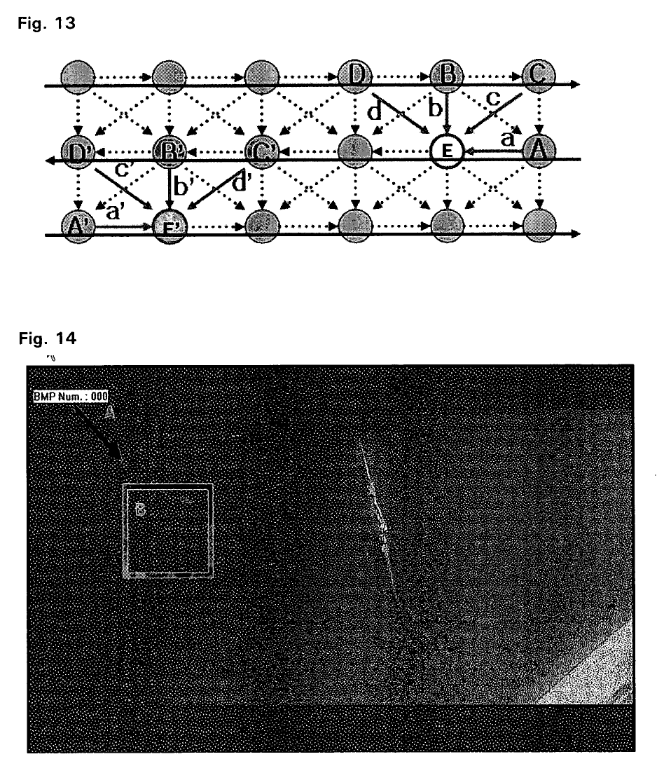

FIG. 13 is a diagram for explaining an error diffusion direction according to one embodiment of the present invention.

Referring to FIG. 13, a diffusion direction of error diffusing into a cell can be differently applied to an odd or even line. For instance, an error component diffuses in left-to-right direction in an odd line, whereas an error component diffuses in right-to-left direction in an even line. Namely, a total of error components of cells A, B, C and D is diffused into a cell E, whereas a total of error components of cells A′, B′, C′ and D′ is diffused into a cell E′. In this case, if the total of the error components diffused into the cell E or E′ is greater than 1, a carry occurs. A decimal value remaining after the carry is multiplied by an error diffusion coefficient to be diffused again into a neighbor pixel.

Thus, in one embodiment of the present invention, the error diffusion direction differs in line unit to suppress the error diffusion pattern attributed to the unidirectional of the error diffusion. Preferably, by setting the error diffusion direction randomly according to the line or cell, the error diffusion pattern can be reduced more efficiently. Such a method of using the random error diffusion direction is defined as random error diffusion by one embodiment of the present invention.

FIG. 14 is a diagram of an image displayed according to one embodiment of the present invention.

Referring to FIG. 14, an image displayed by an error diffusion method according to one embodiment of the present invention has no error directionality at an arrow-A. And, an error diffusion pattern occurring at a specific gray scale of an area-B does not appear unlike the related art.

Thus, by using the error diffusion coefficient allocated according to the gray scale value and by setting up the error diffusion direction randomly, one embodiment of the present invention can reduce the error diffusion pattern appearing according to the related art error diffusion method and the directionality of diffusion.

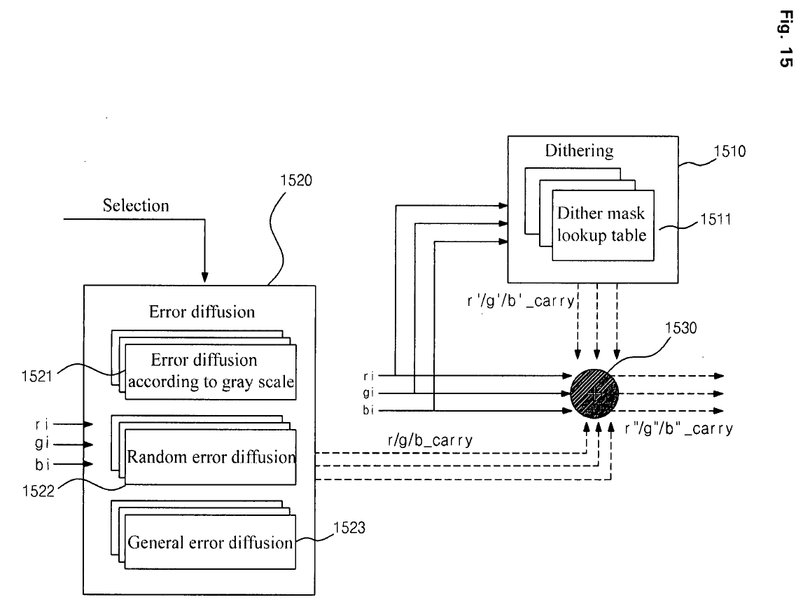

FIG. 15 is a block diagram for explaining a halftone method according to one embodiment of the present invention.

Referring to FIG. 15, data of a video signal inputted from outside is provided with a gray scale value consisting of an integer value and a decimal value through inverse gamma correction per R (red), G (green) or B (blue). One embodiment of the present invention further includes a dithering step 1510 of performing halftoning on the decimal value of the gray scale value of the inverse-gamma-corrected data using a dither mask. And, error diffusion 1520 and dithering 1510 are carried out on the decimal value according to a digit of a significant number.

In the dithering step 1510, halftoning is carried out on upper bits of the decimal value of the gray scale value. In the error diffusion step 1520, halftoning is carried out on lower bits of the decimal value of the gray scale value. In this case, data having the occurrence of a carry by the error diffusion step 1520 performs a carry on a last digit of bits in charge of dithering.

For instance, in case of using a 13-bit decimal value, upper 3-bits are used in the dithering step and lower 10-bits are used in the error diffusion step. The carry occurring in the lower 10-bits is transferred to the upper 3-bits. Moreover, the carry occurring through dithering is transferred to an integer bit having an integer value.

In doing so, in the dithering step, a plurality of dither mask patterns previously stored in a dither mask lookup table 1511 are alternately used by frame unit.

Besides, in the error diffusion step 1520, an error diffusion method 1521 according to a gray scale value differing in an error diffusion coefficient using an error diffusion coefficient lookup table storing error diffusion coefficients therein according to gray scale values and a random error diffusion method 1522 enabling a random setup of an error diffusion direction can be carried out simultaneously or individually. In one embodiment of the present invention, the error diffusion step 1520 can include a general error diffusion method such as Floyd-Steinberg error diffusion 1523 for example.

Accordingly, the halftone method according to one embodiment of the present invention enhances gray scale expression power in the low-gray-scale area and reduces dither halftone noise caused by dithering in the low-gray-scale area. And, by using general error diffusion together with dithering in none-low-gray-scale area having gray scale values over 16, halftone noises occurring in the error diffusion and dithering steps can be cancelled off with each other.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A plasma display apparatus comprising:
an inverse gamma correction unit performing inverse gamma correction on data of a video signal inputted from outside; and
a halftone unit diffusing an error component resulting from multiplying a decimal value of a gray scale value of the inverse-gamma-corrected data by each error diffusion coefficient allocated according to the gray scale value into a neighbor cell.

2. The plasma display apparatus of claim 1, further comprising an error diffusion coefficient lookup table storing unit previously storing information of the error diffusion coefficient allocated according to the gray scale value.

3. The plasma display apparatus of claim 2, wherein the halftone unit selectively uses a plurality of error diffusion coefficient lookup tables differing from each other in information of the error diffusion coefficient for each frame.

4. The plasma display apparatus of claim 1, wherein significant figures of the error diffusion coefficient is at least six bits.

5. The plasma display apparatus of claim 1, wherein the halftone unit diffuses the error component into the neighbor cell in a random direction.

6. The plasma display apparatus of claim 1, wherein the halftone unit performs halftoning on upper bits of a decimal value of the gray scale value of the data through dithering and lower bits of the decimal value through error diffusion.

7. An image processing method of a plasma display apparatus, comprising:
an inverse gamma correction step of performing inverse gamma correction on data of a video signal inputted from outside; and
a halftone step of diffusing an error component resulting from multiplying a decimal value of a gray scale value of the inverse-gamma-corrected data by each error diffusion coefficient allocated according to the gray scale value into a neighbor cell.

8. An image processing method of a plasma display apparatus, comprising:
an inverse gamma correction step of performing inverse gamma correction on data of a video signal inputted from outside; and
a halftone step of diffusing an error component resulting from multiplying a decimal value of a gray scale value of the inverse-gamma-corrected data by an error diffusion coefficient into a neighbor cell in a random direction.

9. An image processing method of a plasma display apparatus, comprising:
an inverse gamma correction step of performing inverse gamma correction on data of a video signal inputted from outside; and
a halftone step of diffusing an error component resulting from multiplying a decimal value of a gray scale value of the inverse-gamma-corrected data by each error diffusion coefficient allocated according to the gray scale value into a neighbor cell in a random direction.

10. The image processing method of claim 7 or claim 9, further comprising an error diffusion coefficient lookup table storing step of previously storing information of the error diffusion coefficient allocated according to the gray scale value.

11. The image processing method of claim 10, wherein in the halftone step, a plurality of error diffusion coefficient lookup tables differing from each other in information of the error diffusion coefficient are selectively used for each frame.

12. The image processing method of claim 7, claim 8 or claim 9, wherein significant figures of the error diffusion coefficient is at least six bits.

13. The image processing method of claim 7, claim 8 or claim 9, wherein in the halftone step, halftoning is performed on upper bits of a decimal value of the gray scale value of the data through dithering and lower bits of the decimal value through error diffusion.
